(19) United States
(12) Patent Application Publication
(10) Pub. No.: US 2014/0380229 A1
(43) Pub. Date: Dec. 25, 2014

(54) SYSTEM, METHOD AND USER INTERFACE FOR DESIGNING CUSTOMIZABLE PRODUCTS FROM A MOBILE DEVICE

(71) Applicant: VISTAPRINT SCHWEIZ GmbH, Winterthur (CH)

(72) Inventors: Ilya Volodin, Waltham, MA (US); Laban Eilers, Framingham, MA (US); Staci Dubovik, Framingham, MA (US); Aaron Richmond Shimoff, Somerville, MA (US); Mansim Connie Cheng, Waban, MA (US); Matthew Aaron Gittlitz, Bellingham, MA (US)

(73) Assignee: VISTAPRINT SCHWEIZ GmbH, Winterthur (CH)

(21) Appl. No.: 14/313,950

(22) Filed: Jun. 24, 2014

Related U.S. Application Data
(60) Provisional application No. 61/838,865, filed on Jun. 24, 2013.

(51) Int. Cl. G06F 3/0484; G06F 3/0482

(52) U.S. Cl. CPC G06F 3/04842; G06F 3/0482
USPC 715/780

(57) ABSTRACT

A methodology and user interface enabling a user to create and edit a product design from an electronic device includes features that are particular optimal for designing customized products from mobile devices. By integrating form control with WYWIWYG presentation and including zoom and edit control independently and directly associated with the visual presentation element itself, users of mobile device experience a cleaner simplified design process, leading to more satisfied customers.

### CROSS REFERENCE TO RELATED APPLICATIONS

This application claims priority under 35 U.S.C. §119(e) of U.S. Patent Application No. 61/838,865, filed Jun. 24, 2013, which is hereby incorporated by reference in its entirety.

### BACKGROUND

The marriage of mobile phones and wireless networking, as currently embodied in mobile devices such as smartphones and tablet computers, has revolutionized the way, and frequency at which, people access and use the Internet. The convenience and availability of a browser and data connectivity in a single mobile device allows people to access information available over the Internet at nearly any time and from nearly any place, providing nearly instant gratification of receipt of information and accomplishing tasks that are achievable via a web browser.

The number of people accessing the Internet via mobile devices is outpacing those accessing the Internet from traditional desktop and even laptop devices. With the explosion in the frequency of smartphone and tablet computer usage, there has been a simultaneous increase in e-commerce transactions conducted via such mobile devices versus via traditional desktop and laptop computing devices. For retail businesses, it is therefore critical to have a mobile website with a simple-to-use aesthetically pleasing graphical user interface in order to prevent customer drop-off and to facilitate sales.

### SUMMARY OF THE INVENTION

Embodiments of the invention include a user interface, systems, and methods for customizing a product design from an electronic device.

One embodiment includes a user interface for customizing a product design. The user interface includes a container containing a visual representation of the design displayed on an electronic display. The visual representation of the design depicts the design in its current form in a What-You-See-Is-What-You-Get (WYSIWYG) depiction, and includes a plurality of customizable elements that are individually selectable by a user via direct touch on a corresponding area of the electronic display. The user interface further includes a plurality of user interface controls. The user interface controls include a form control responsive to user input to set the form control into one of a plurality of form control states including at least an expanded state, a contracted state, and a partially contracted state. The expanded state is configured to expose for display on the electronic display a plurality of user-editable form fields corresponding to the plurality of customizable elements of the visual representation of the design and wherein each user-editable field is configured to receive content from the user whereby the received content corresponds to corresponding visual content of the corresponding element in the visual representation of the design. The contracted state is configured to hide the user-editable form fields from view on the electronic display. The partially contracted state is configured to display on the electronic display only the user-editable form fields corresponding to currently selected elements in the visual representation of the design.

The user interface further includes a customization control responsive to user input to set the customization control into one of a plurality of customization control states including at least a contracted customization control state in which an expanded set of customization option controls is hidden from view on the electronic display and an expanded customization control state in which the expanded set of customization option controls is exposed for view on the electronic display and for user interaction, the set of customization controls configured to allow the user to configure different visual features of the visual content of the respective elements in the visual representation of the design. The container is configured to allow a user to scroll and zoom the visual representation of the design within the container without simultaneously scrolling or zooming user interface controls on the electronic display. Furthermore, direct touch selection of an individual customizable element on the visual representation of the design triggers display of the form control configured in the partially contracted state.

One embodiment includes a method for enabling a user of an electronic device to customize a product design via a user interface displayed on an electronic device. The method includes displaying in the user interface a design within a container, the design comprising a plurality of individually selectable elements, the container configured to allow zooming and scrolling of the design within the container. The method further includes displaying, within the user interface and outside the container, a plurality of design editing controls. The method further includes receiving at least one of a zoom event and a scroll event associated with the container and performing corresponding zooming or scrolling action to zoom or scroll the design within the container, wherein the design editing controls are unaffected by zooming or scrolling action. The method further includes receiving at least one selection event within the container, the at least one selection event corresponding to use selection of an individual element of the design. The method further includes receiving at least one design editing control events and performing a corresponding design edit action associated with the received design editing control event, the action performed on the selected individual element of the design. Optionally, the at least one selection event triggers display of a partially contracted form field control which displays a user editable input field for editing content of the selected individual element of the design.

### BRIEF DESCRIPTION OF THE DRAWINGS

A more complete appreciation of this invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic block diagram of the architecture of a website;

FIG. 2 is a high-level schematic block diagram of an exemplary system in which embodiments of the invention may operate;

FIG. 3 is a schematic block diagram of a template component assets database;

FIGS. 4A-4T are exemplary screen shots displayed on an electronic display screen of an electronic device and depict various features of the inventive user interface;

FIG. 5 is a flow diagram illustrating an exemplary user interface flow operation in accordance with principles of the invention.

FIG. 6 is a more detailed schematic block diagram of an exemplary system in which embodiments of the invention may operate;

FIG. 7 is a schematic block diagram of a computing device such as a server device or a client electronic device.

### DETAILED DESCRIPTION

The challenge for designing websites optimized for mobile devices lies in the smaller screen size of mobile devices versus the screen size typically available from desktop or laptop computer monitors. Key to the amount of information that can be displayed on an electronic display, or “screen”, is the electronic display screen resolution—that is, the number of pixels available for rendering content on the screen of the electronic display. A traditional desktop monitor may include 1280 pixels across by 1024 pixels top-to-bottom (in typical nomenclature, 1280×1024 pixels). Even the lowest resolution desktop monitor will typically have a resolution of at least 640×480 pixels. In contrast, a typical smartphone has a screen resolution of 300×480 pixels. Thus, not only is the orientation different (portrait orientation versus landscape orientation), more importantly there are fewer pixels available on a smartphone to impart information. Thus, less content can be displayed at any given time on a smartphone screen than on a desktop or laptop monitor.

The lower-resolution screen must be accounted for when designing mobile websites. To address this issue of limited resolution, many mobile websites are designed to include fewer text and image elements, limited user functionality, and/or to take more advantage of window scrolling. Some mobile website designers break up the functionality of a traditional website page into two or more mobile website pages, and some mobile websites provide zoom functionality to allow the user of the mobile device to zoom in on a smaller portion of content on the web page in order to inspect the smaller portion of the web page in higher resolution. All of the above techniques are employed to improve the user experience of the website when accessed from a mobile device.

Some retailers, such as Vistaprint which operates a website for example associated with the domain name www.vistaprint.com, sell products which may be customized or designed by a customer/user visiting the website. When a customer/user (hereinafter “user”), is allowed to make design selections and/or add customization to a product, it can be important to provide a preview of the product prior to user purchase of the product in order to ensure that the user understands what the product will look like and how the user's selections and/or customizations affect the appearance of the base product.

When a website provides design functionality, user input is often captured by way of a form presented in a web page. In the case of a product that will include text and/or image customization, individual text and/or image elements of the product design may correspond to individual fields of the form. Users may set the text and/or image content on the product by entering corresponding text and/or image content (or referencing a location of the image to be incorporated into the corresponding image element on the product) into the respective form fields associated with the text and/or image elements of the product. For an improved user experience, a visual representation of the current product design is displayed simultaneously with the form so that as the user enters text or image information into the form field input boxes, the corresponding elements in the visual representation of the current product design are updated to match the field content or style modifications.

On a mobile device, display of a form simultaneously with a visual representation of the current product design (as customized by the user) is difficult due to the limited resolution of the screen, yet the need for a visual representation of the current product design does not decrease.

Accordingly, the present invention provides a unique design experience available inside a browser on a mobile device that includes both form functionality and visual representation functionality, with the further ability for users to view and perform design editing directly on the visual representation of the current product design to modify the underlying product design itself. In order to assist the user in visualizing the overall product, an editable visual representation of the current product design is displayed on the mobile website product design page in addition to other page elements such as a form control, a product design approval control, one or more product editing control(s), navigation element(s), and, if appropriate, additional text and/or image elements. The editable visual representation of the current product design is contained within a container which includes a separate zoom control and/or scroll control configured to allow a user to zoom and scroll the editable visual representation within the container. Individual elements in the editable visual representation of the current product design (corresponding to form fields in the form element) are user editable. This allows a user to edit the product design from either or both of the form field(s) and/or the editable visual representation of the current product design in order to make actual changes to the product design document.

System

In general, embodiments described below feature a design application which allows a user to select a template and customize it with personalized content and style selections from a mobile device such as a smartphone or tablet/pad device. A product design page or application is downloaded to the device by a server. The product design page/app includes script implementing functionality that allows dynamic WYSIWYG display rendering as user-made selections and edits are made to a user-selected template. Features such as in-container scrolling and zooming, touch-based element selection directly from a design preview, control expansion/contraction, and partial form display based on element selection context enables detailed design of document products on a small form-factor screen

An introduction to Internet-related technology is helpful in understanding the present invention. The Internet is a vast and expanding network of computers and other devices linked together by various telecommunications media, enabling the various components to exchange and share data. Web pages and websites (collections of related web pages organized under a particular domain), accessible through Internet, provide information about numerous businesses, products and services, as well as education, research, and entertainment.

An integral component of the system is a computer server. Servers are computer programs that provide some service to other programs, called clients. A client and server communicate by means of message passing often over a network, and use some protocol, a set of formal rules describing how to transmit data, to encode the client's requests and/or responses and the server's responses and/or requests. The server may run continually waiting for client's requests and/or responses to arrive or it may be invoked by some higher-level continually running server that controls a number of specific servers.

A resource that is attached to the Internet is often referred to as a “host.” Examples of such resources include conventional computer systems that are made up of one or more processors, associated memory and other storage devices and peripherals, such as modems, networks interfaces and the like that allow for connection to the Internet or other networks. In most cases, the hosting resource may be embodied as hardware and/or software components of a server or other computer system that includes an interface module, which allows for some dialog with users and that may process information input by the user. Generally, such a server will be accessed through the Internet's graphical user interface, the World Wide Web, (e.g., via Web browsers) in the conventional fashion.

In order to facilitate communications between hosts, each host has a numerical Internet Protocol (IP) address. The IP address of a hypothetical host computer might be 69.17.223.11. Each host also has a unique “fully qualified domain name.” In the case of the hypothetical host 69.17.223.11, the “fully qualified domain name” might be “computer.domain.com”, the three elements of which are the hostname (“computer”), a domain name (“domain”) and a top-level domain (“com”). A given host looks up the IP address of other hosts on the Internet through a system known as domain name service.

A page of a website is addressable by way of a Uniform Resource Locator, or “URL”. A URL specifies three elements: (1) a transfer protocol; (2) a web server name or domain name; and (3) a path. The first element of the URL is a transfer protocol, most commonly “http” standing for hypertext transfer protocol, but others include “mailto” for electronic mail, “ftp” for file transfer protocol, and “nntp” for network news transfer protocol. The domain name indicates the name of the web server that stores the web page. The path indicates the location of web page on the named web server.

In order to access the Internet most users rely on computer programs known as “Web browsers.” Commercially available Web browsers include such well-known programs as Microsoft Corporation's Internet Explorer®, Apple Inc.'s Safari®, Google Inc.'s Chrome®, and Mozilla Foundation's Firefox®, to name a few. If an Internet user desires to view a Web page hosted at www.domain.com, the Internet user might enter into a Web browser program the uniform resource locator (URL) “http://www.domain.com”.

Once a URL is entered into the browser, the request is routed to a Domain Name System (DNS) server capable of matching the domain name specified in the URL to a corresponding IP address of a web server hosting the requested web page. Thus, the DNS server ultimately matches an alphanumeric name such as www.domain.com with its numeric IP address 69.17.223.11.

When a host receives a request from the Internet, it returns the data in the file pointed to by the request to the client making the request. Such data may make up a Web page, which may include a text message, sound, image, video, or a combination of such elements. A user can move between Web pages through the use of hyperlinks, which are links to other pages or locations on pages on the Internet.

A traditional website is a set of one or more web pages served by a web server at a particular domain name. A web page is typically a text document containing text and browser-interpretable instructions, such as the well-known HyperText Markup Language (HTML), eXtensible HyperText Markup Language (XHTML), Dynamic HTML (DHTML), Document Object Model (DOM), etc. A web browser running on a client machine requests a web page by specifying the Universal Resource Locator (URL) of the specific page, and upon receiving the requested page from the server, renders the page on the user's display screen by processing and executing the browser-interpretable instructions. Web pages may be linked to other web pages by way of hyperlinks placed within the page(s). Typically, a hyperlink specifies a URL of a web page, a position in the web page, or a resource accessible by the server serving the web page.

A typical website consists of a home page that is served when the URL specifies the domain name without specifying a particular path (e.g., www.mycompany.com). Additional pages belonging to a website may be specified by way of the path following the domain name in the URL. For example, a “Contact” web page for the www.mycompany.com website may be specified as “www.mycompany.com/Contact”, where the path “/Contact” in the URL indicates the location at the web server of the “Contact” web page.

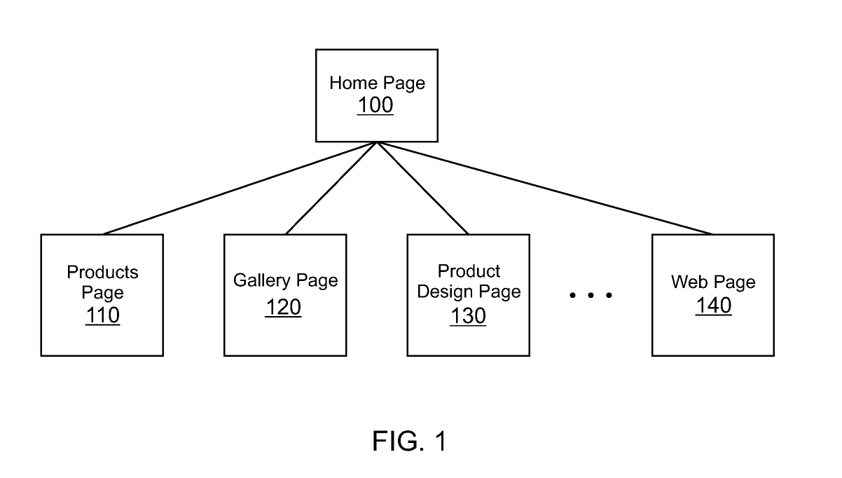

With reference now to FIG. 1, a website may consist of a plurality of related web pages 100, 110, 120, 130, 140, each comprising a browser-renderable document (for example, an HTML document). In the example shown in FIG. 1, a website includes a Home Page 100, a Product Selection page 110, a Gallery page 120, a Product Design page 130, and one or more additional web pages 140.

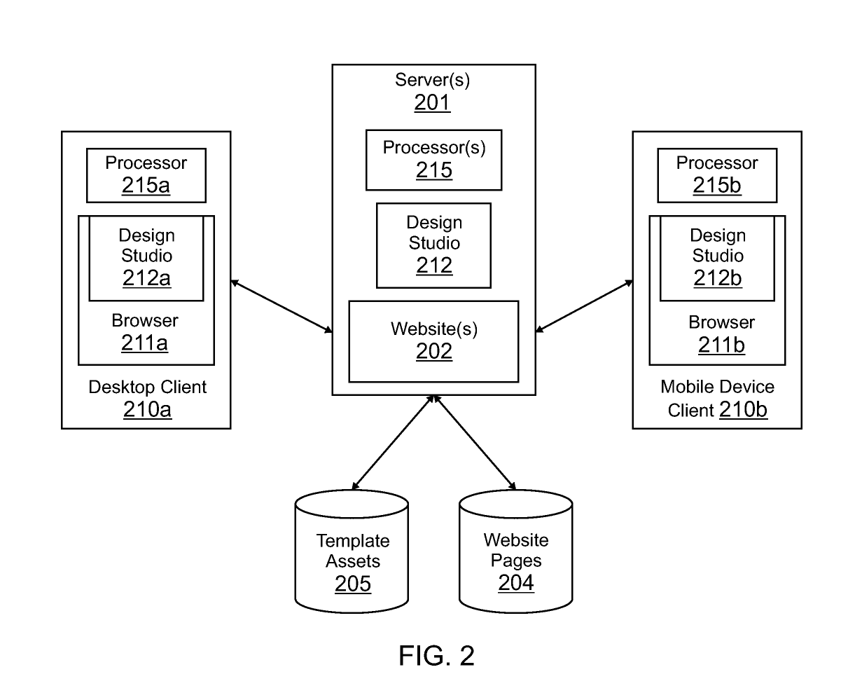

FIG. 2 is a high-level schematic block diagram of an embodiment of a system in which the present invention may operate. One or more server(s) 201 hosting one or more website(s) 202 are configured to allow operable communication with Internet-enabled client devices, including mobile devices 210b such as smartphones and Internet-enabled handheld devices (such as the Apple iPhone/iPad/iPod, Google Android, Samsung Galaxy, and other such devices). Although the invention is targeted at devices having smaller electronic display screens, the server(s) 201 may further be configured to allow operable communication with traditional computer devices 210a such as desktop and laptop computers as well. The server(s) 201 host one or more websites 202 which allow a user of a client device 210a, 210b to quickly create and edit a design of a printed document, an electronic product, or other physical product. The server(s) 201 are operated under the control of one or more processor(s) 215 of a computing device.

A website 202 may include design studio functionality which is generally available to a client device 210a, 210b upon the user navigating to a website 202 hosted by the server(s) 201 and activating a control (for example, by clicking on a button or link displayed in a web page) on the website 202 to request download of a design studio application 212a, 212b (referred to generally hereinafter as 212) to the requesting client device 210a, 210b, to execute in a browser 211a, 211b running under the control of at least one processor 215a, 215b on the client device.

The design studio application 212 detects the type of the client device. Preferably, at a minimum, the design studio application 212 determines whether the device type is a mobile device or a traditional computing device. Preferably, the design studio application 212 determines much more than merely whether the requesting device is a mobile device or a traditional device, including the device make and model, operating system, and hardware configuration. In an embodiment, the design studio application 212 reads the operating system configuration to determine the device type and operating system type and version. Other device type, system and hardware configuration may be obtainable by reading configuration information stored in one or more configuration locations in static device memory (e.g., device Read-Only Memory (ROM) or static Random Access Memory (RAM)).

In an embodiment, the design studio application 212 is one or more set(s) of JavaScript code that is downloaded by the server(s) 201 to a requesting client device 210a, 210b. In an embodiment, when the design studio application 212 is downloaded to the client device 210a, 210b, the design studio application 212 presents a gallery of different template designs from which the user may select using a graphical user interface control on the display device of the client device 210a, 210b. Upon receipt of a user's template selection, the design studio application 212 sends the identifier of the selected template to the server(s) 201, which retrieves the template preview 310 (comprising a plurality of different template assets associated with the selected template) from the template assets database 205 and downloads the template to the client device 210a, 210b.

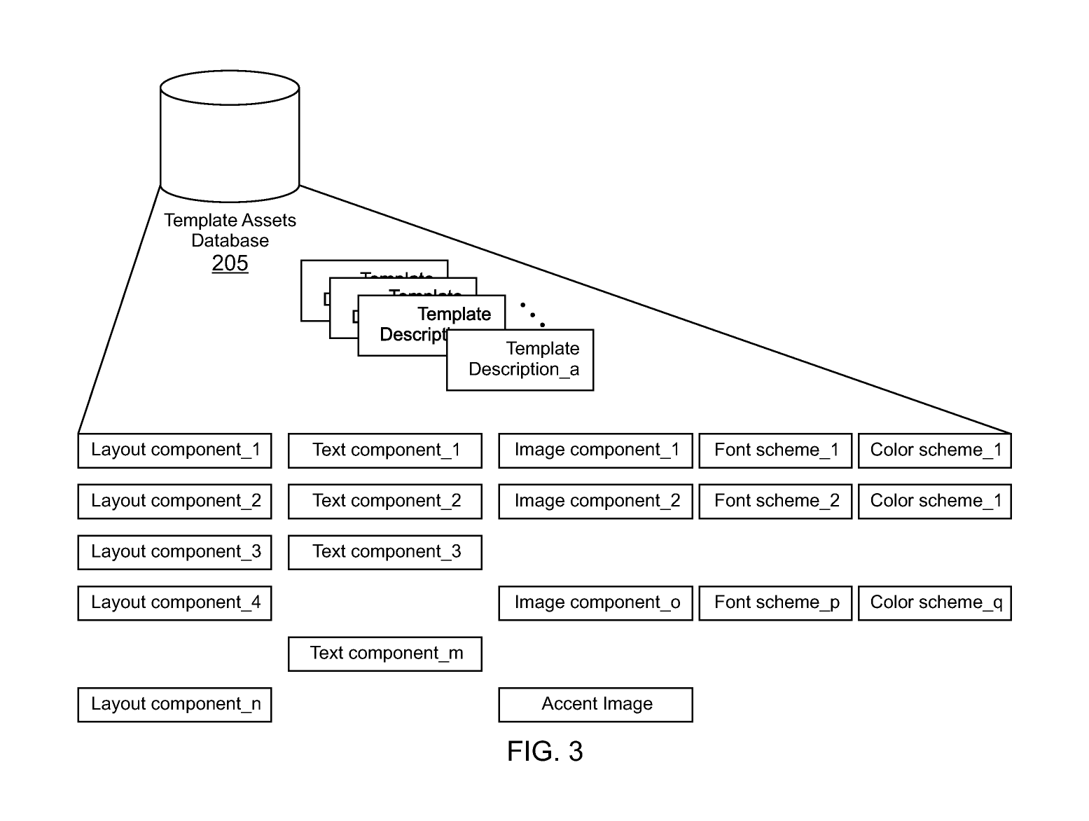

FIG. 3 depicts a structural diagram of a portion of a template assets database 205. The template assets database 205 contains components and descriptions such as layouts, text elements, image elements, headers, navigational components, footers, color schemes, accent images, font schemes, template descriptions, and any type of component or scheme that may be used as a component in a printed document, web page, or other product on which a design is presented or embodied. A design to be printed on a substrate (for example to produce a printed product) may include a plurality of different components arranged (such as layouts, headers, footers, backgrounds, text components, and images) and/or applied (such as color schemes, font schemes, backgrounds, layouts, etc.) according to a page description (typically .html).

As mentioned, the design studio application 212, 212a, 212b is downloaded to a requesting device 210a, 210b. In an embodiment, the active functionality for the product design page is implemented in one or more sets of JavaScript, which may be downloaded to execute locally within the client browser. The page functionality appears to the user as a set of web pages that naturally sequence from page to page. However, unlike a traditional navigation of a website, graphical user interface screens of the design studio application 212, 212a, 212b need not in fact be separate web pages and are therefore are not necessarily served by the server(s) 201 when navigating from what appears to be “page” to “page”. This significantly reduces the back and forth communication between the server(s) 201 and client device 210a, 210b during the creation and editing of a client user's product design.

Upon receipt of a user's template selection, the design studio application 212, 212a, 212b sends the identifier of the selected template to the server(s) 201, which retrieves the template preview 310 (comprising a plurality of different template assets associated with the selected template) from the template assets database 205 and downloads the template to the client device 210a, 210b.

User Interface

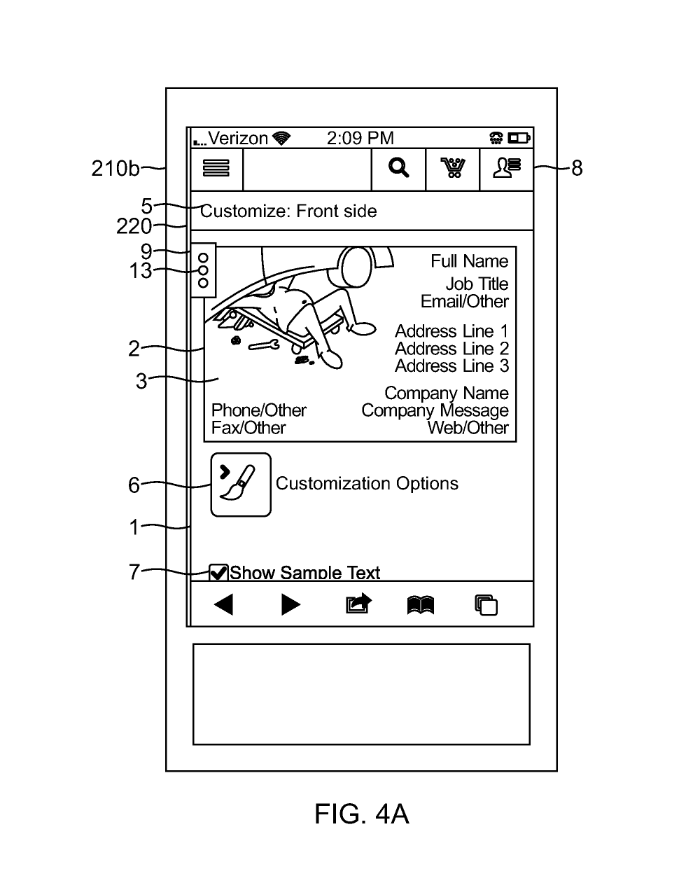

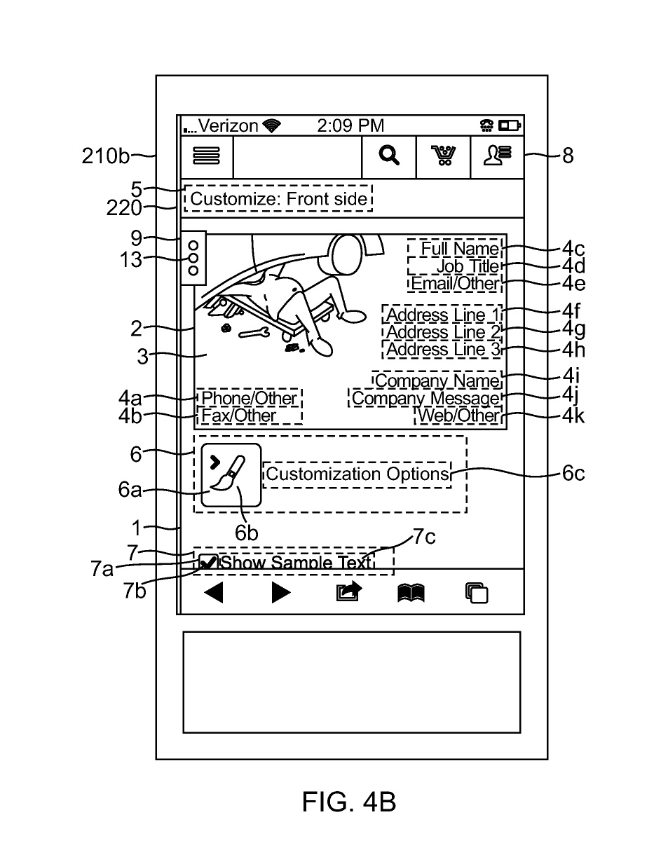

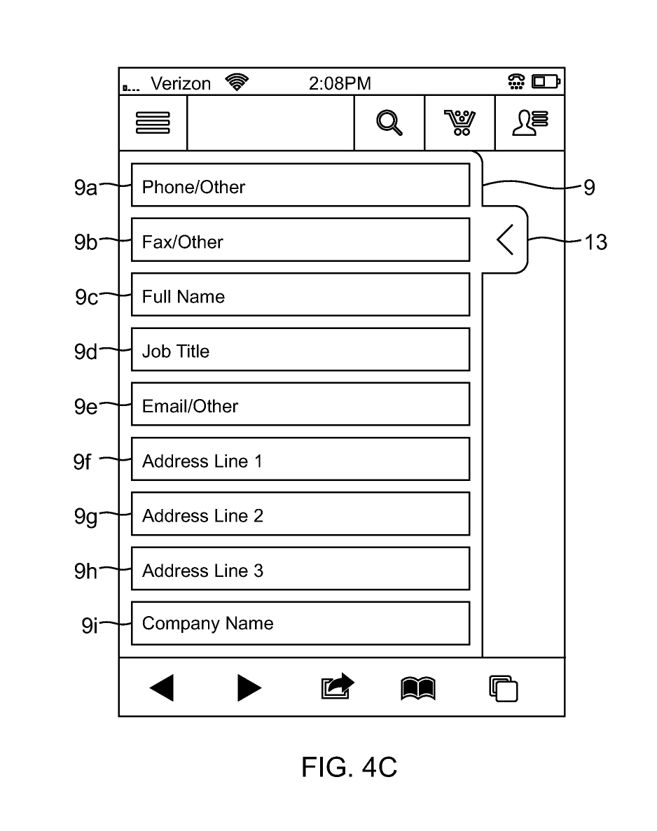

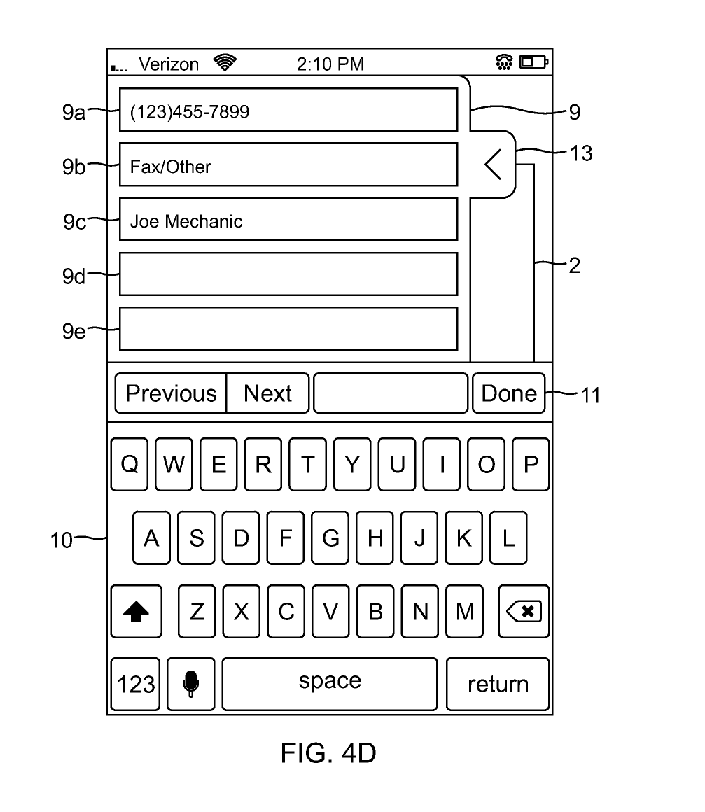

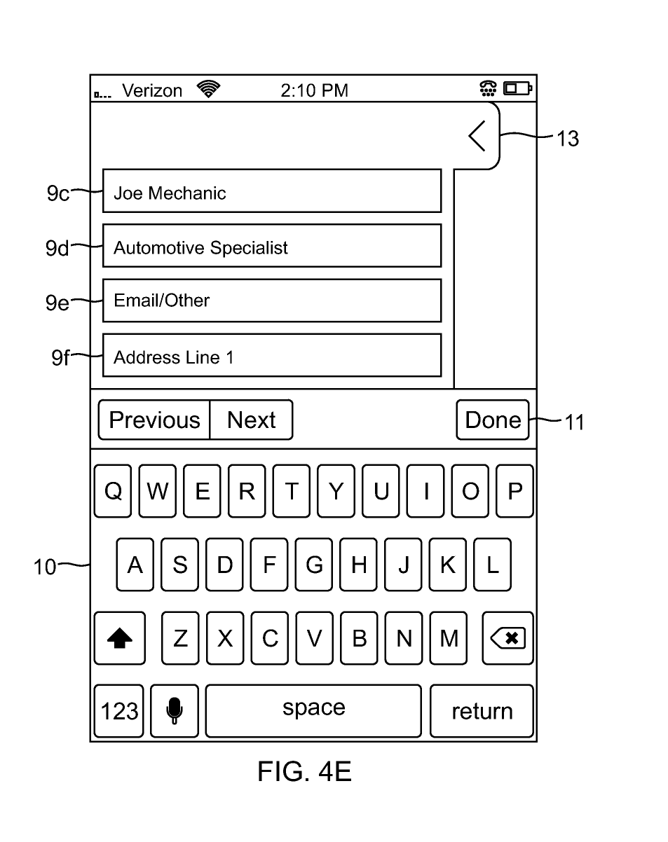

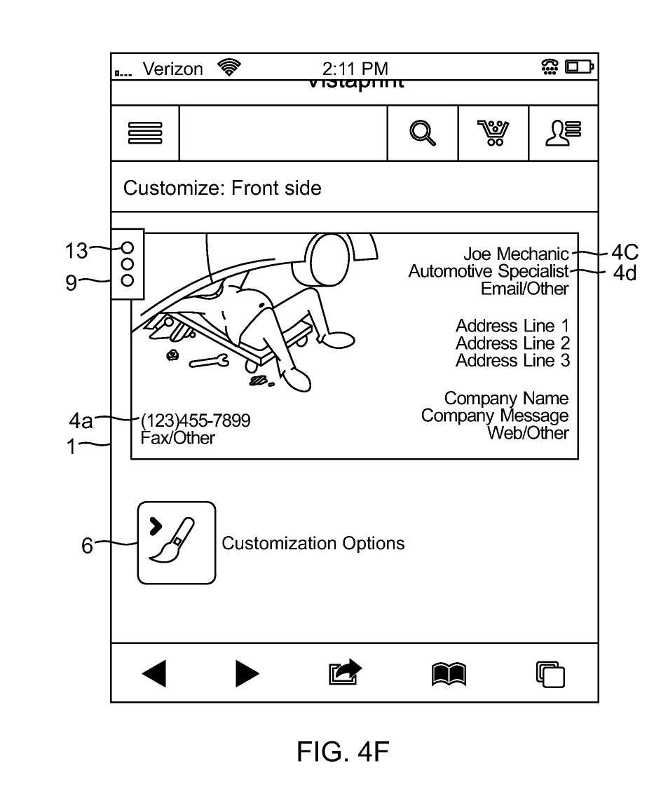

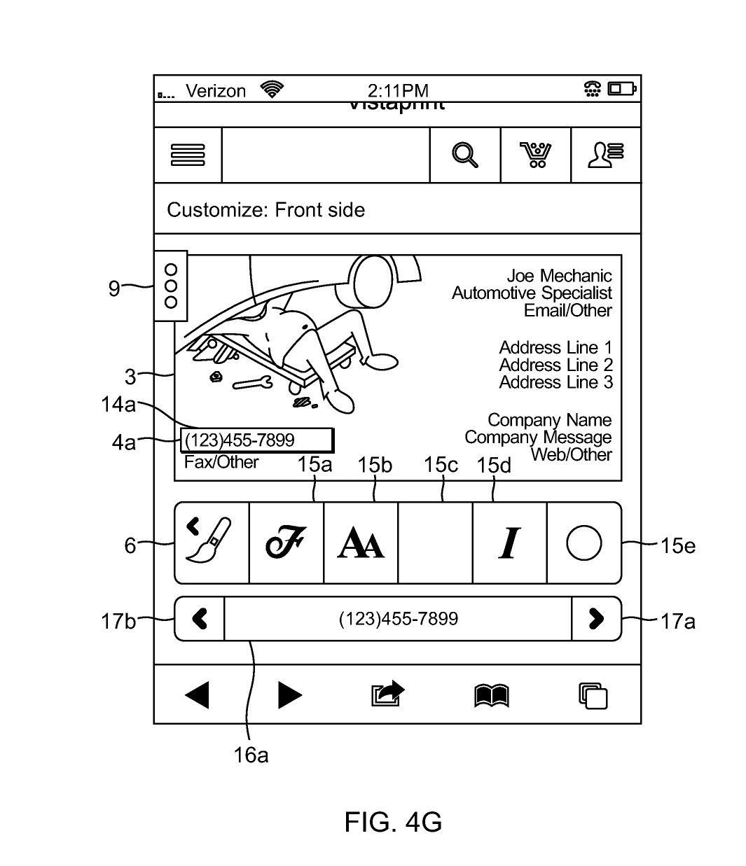

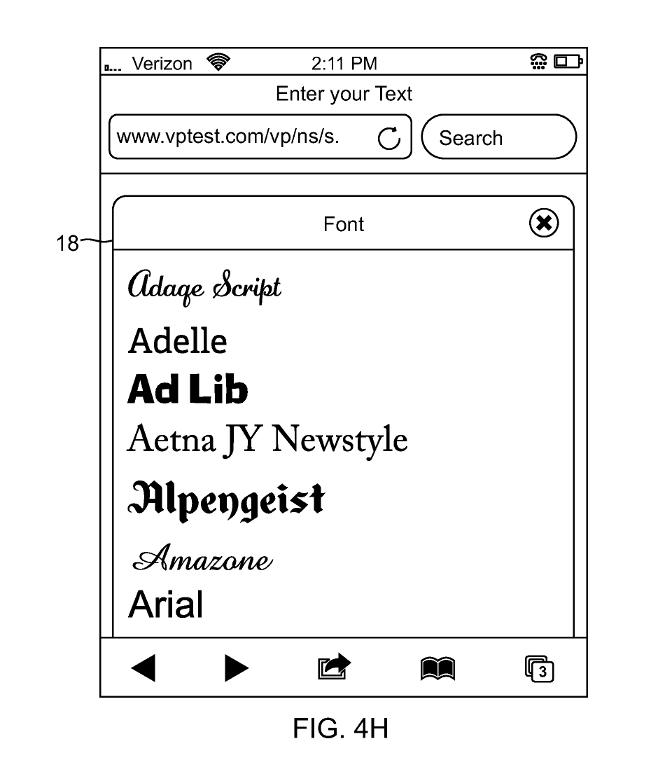

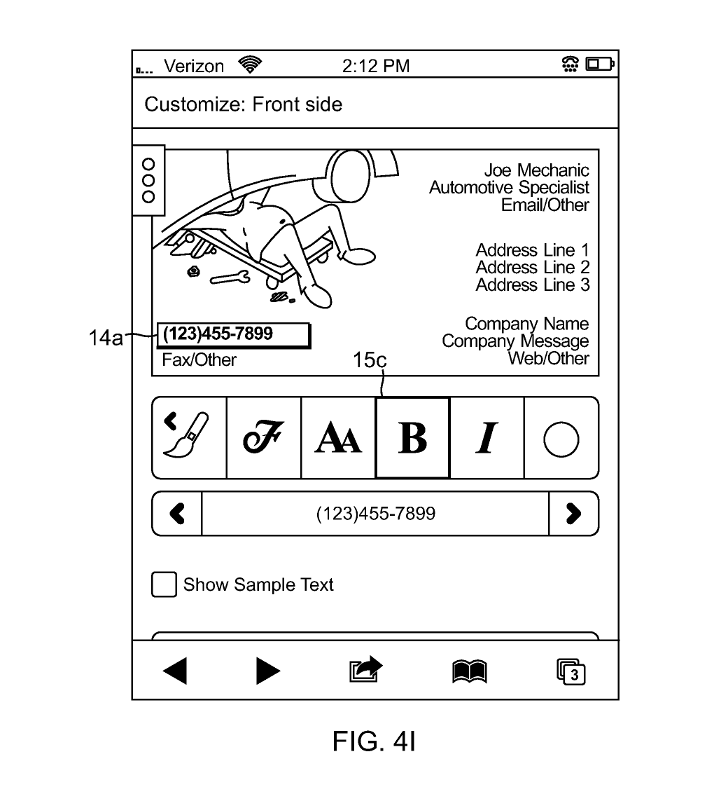

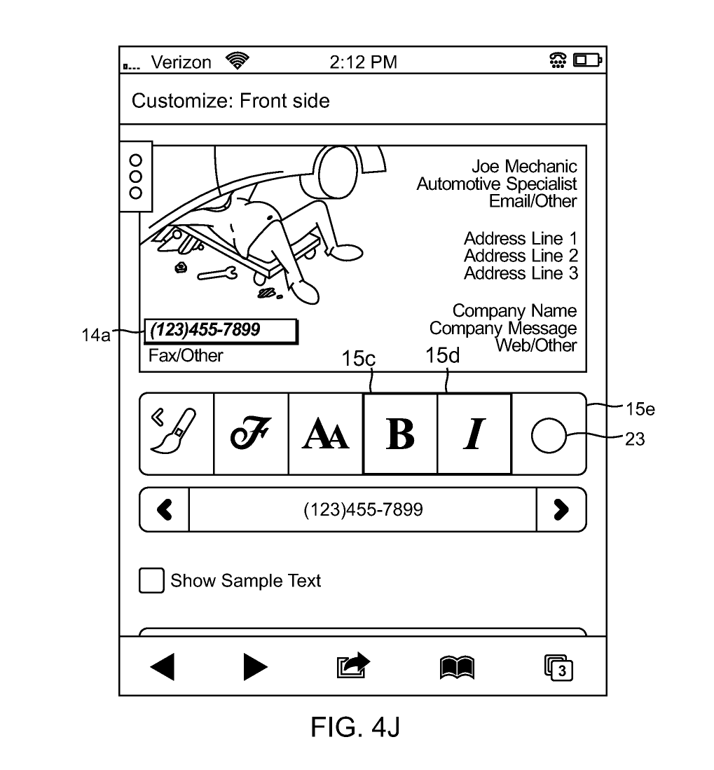

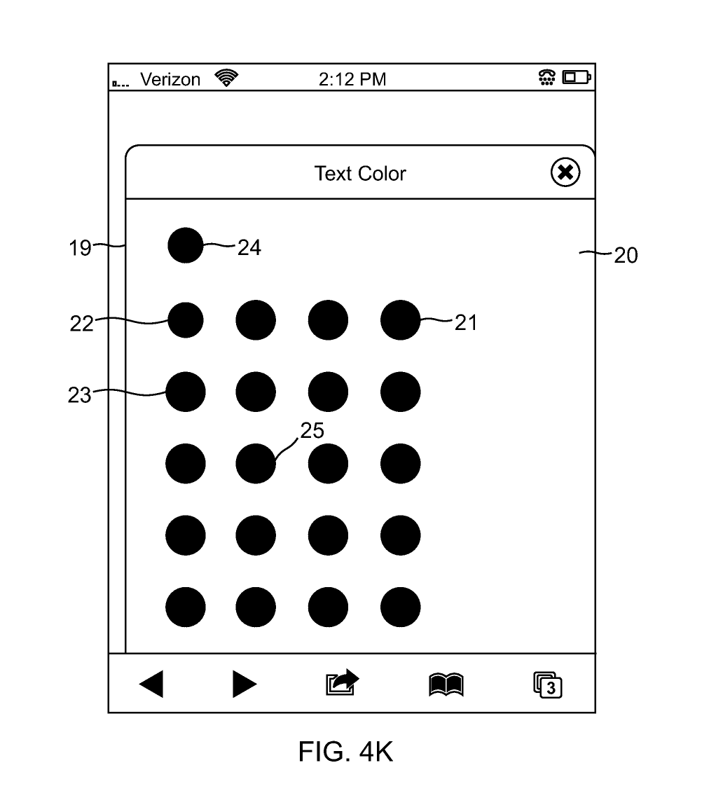

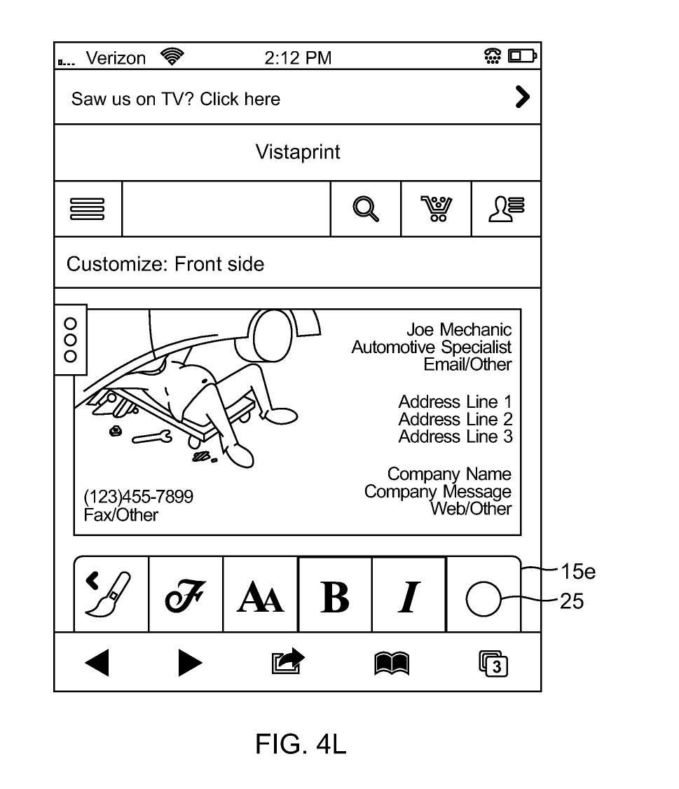

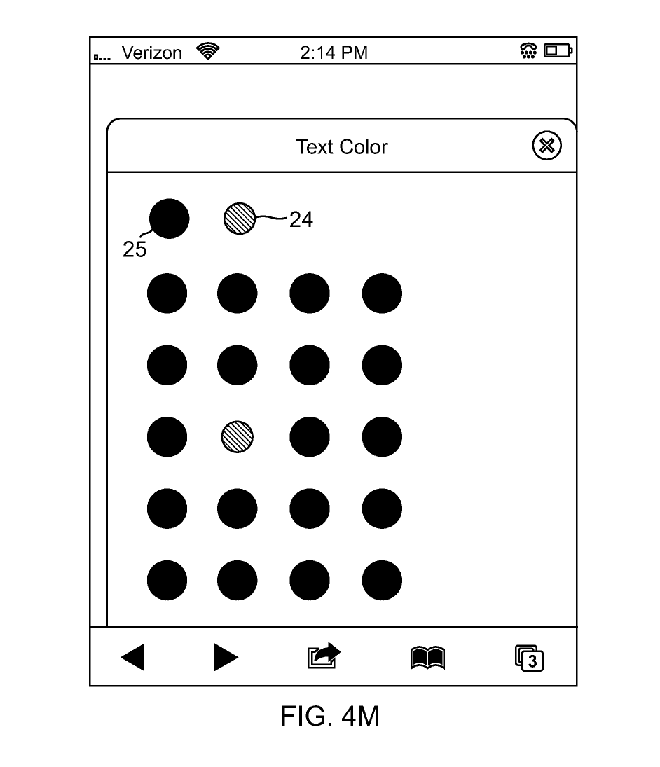

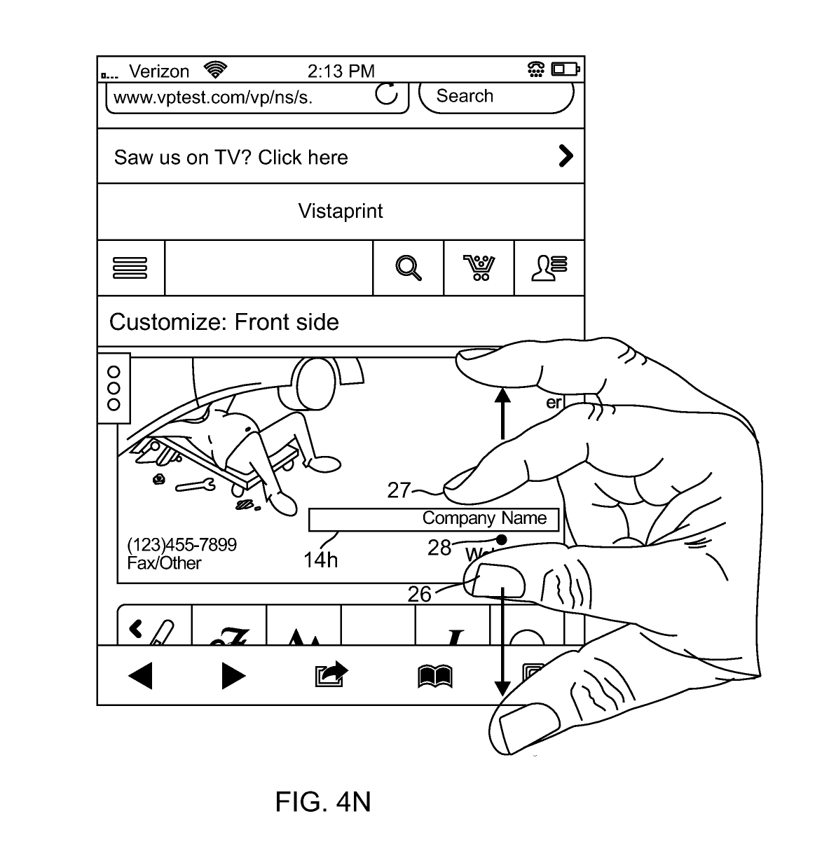

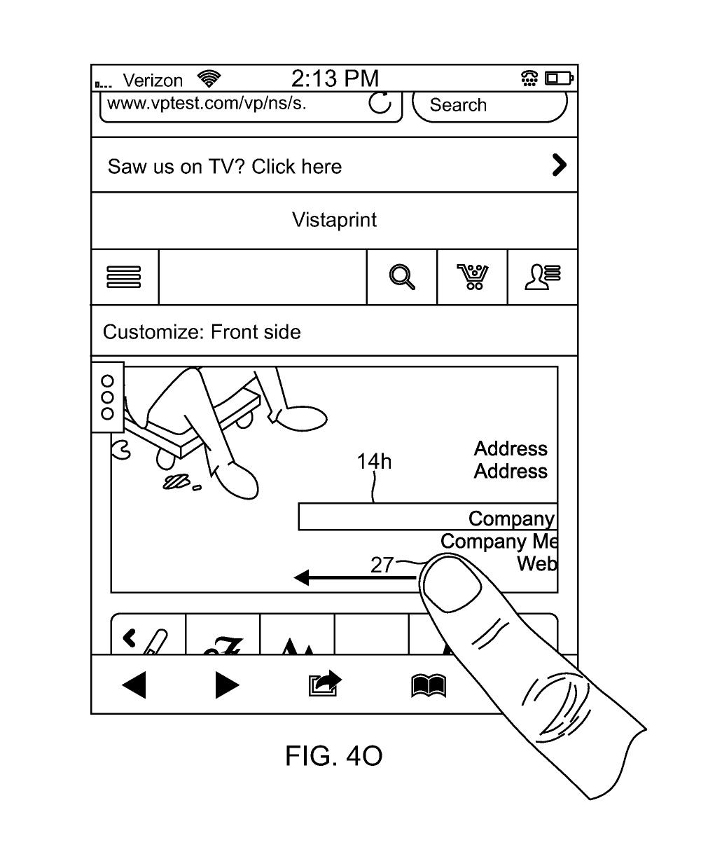

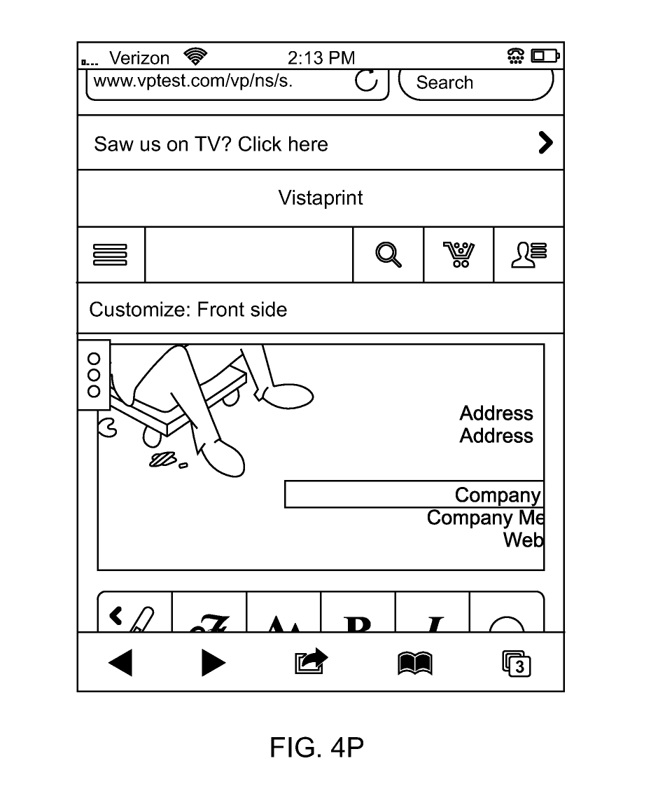

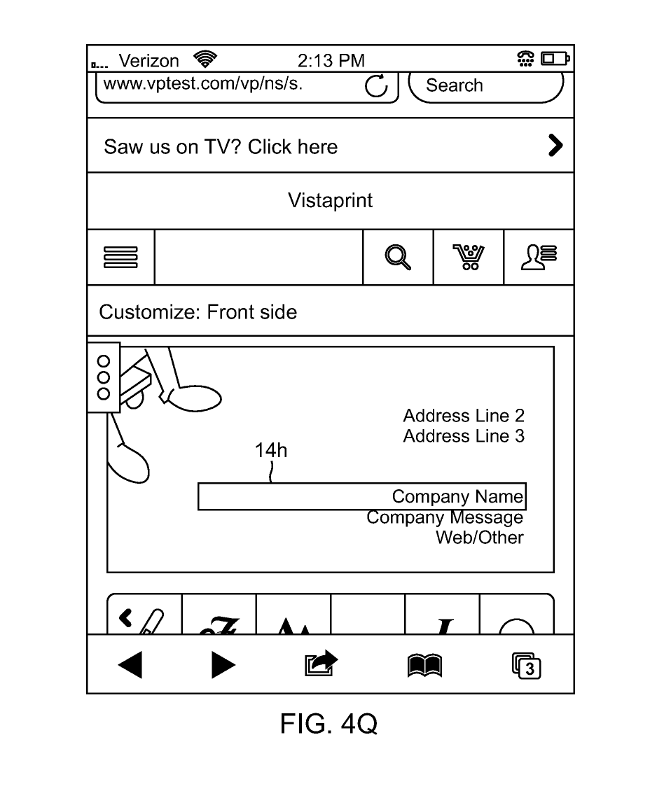

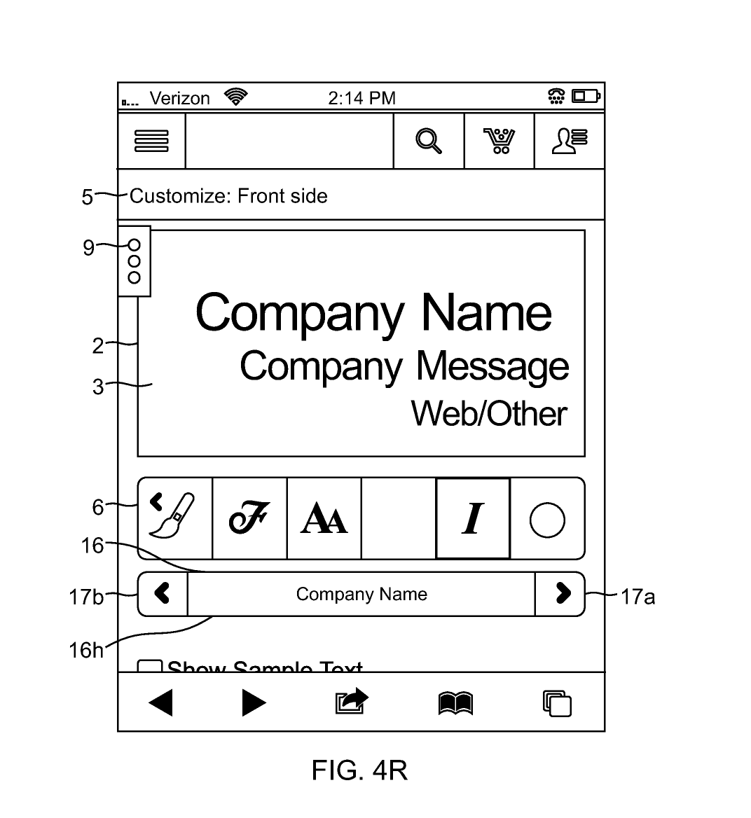

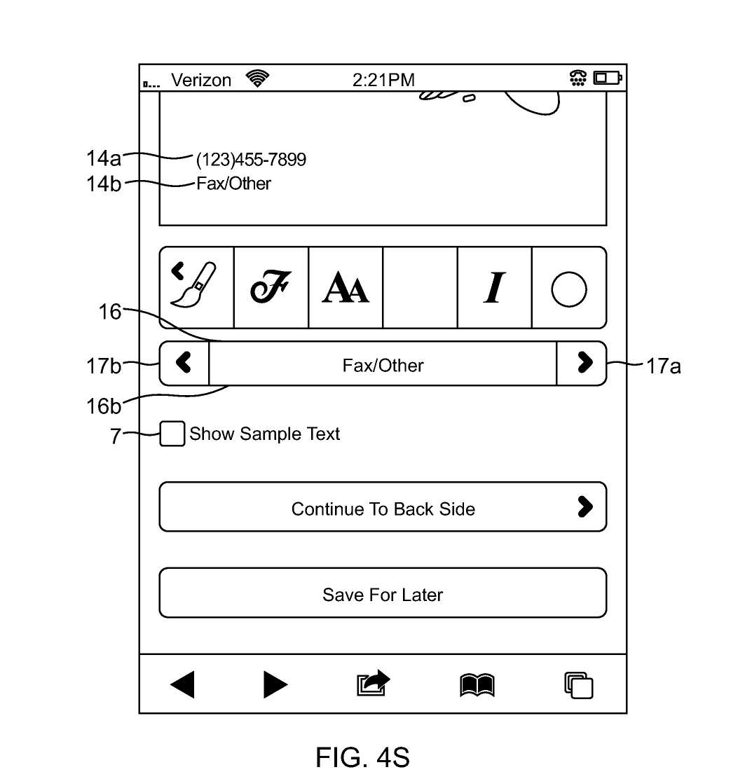

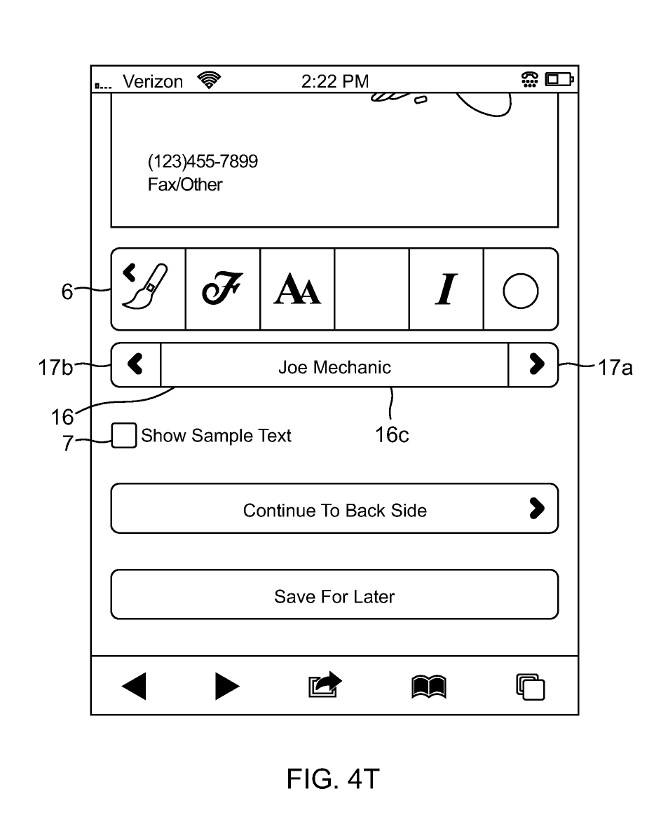

In an embodiment, the design studio application 212, 212a, 212b displays a graphical user interface which includes a product design page 1. FIG. 4A depicts an example product design page 1. In an embodiment, the product design page 1 is implemented as a browser-renderable document. In a preferred embodiment, the design page 1 comprises one or more source code documents (which could include the main page source code document which references additional source code documents). The elements of the design page 1 are preferably implemented as HyperText MarkUP (HTML) elements or elements of a variant thereof (including but not limited to XHTML, DHTML, HTML5, etc.). The presentation may be separated from the content of the page using separate style definitions (for example by way of use of cascading style sheets (CSS)). Much of the functionality is preferably performed using scripting, which may be coded directly in the page source code itself, or which may be downloaded to execute locally within the mobile device, or which may execute the script remotely via server calls.

The source code of the design page 1 defines the position and style each of the elements to be rendered and displayed on the electronic display screen of the electronic device. The design page may include a number of different elements, such as text elements, image elements, title elements, heading elements, paragraph elements, container elements (e.g., <DIV> elements), etc. While most of the page elements may be positioned relatively, the elements of the selected template (i.e., the HTML representation of the editable visual representation 3) are defined absolutely within the template element. Absolute positioning of the nested elements within the template element is required because the template element is rendered as a visual representation of the product design and must be accurately represented—that is, the editable visual representation 3 of the current product design must look exactly like the final actual product design that is printed, attached, displayed, engraved, embroidered, adhered, attached, etc., to the physical product. The editable visual representation 3 is thus a WYSIWYG representation.

The selected template is typically selected by the user because the user desires to take advantage of previous design work done by a professional designer. Thus, many of the template elements may be locked to user editing to prevent the customization of the design by the user from straying too far from the intent of the original designer. For example, a template may comprise a layout, a background image, a number of text components, a number of foreground image components, a color scheme, and a font scheme. The provider of the template may desire to allow editing of only certain ones of the total number of template components, or may desire to allow only certain attributes of the components (e.g., color, font) to be editable while locking other attributes (e.g., position). Each of the element attributes and style properties can be made editable (unlocked to user modification) or non-editable (locked to user modification) by the template designer.

The template element may be the selected template converted into an HTML representation and discussed herein as the editable visual representation of the design 3.

In an embodiment, the container 2 in the product design page 1 which contains the visual representation of the design 3 is implemented as an HTML <DIV> element (or “container” element) which inherits its styles from a style sheet (typically a CSS) which selects the particular <DIV> element to declare its overflow property to be hidden (i.e., the overflow property of the <DIV> element is configured as overflow-hidden). In this embodiment, the container element is configured to contain the template element (i.e., the editable visual representation 3).

When a user navigates to a website 202 that offers templates for selection and customization by the users, the website 202 will typically include one or more gallery pages which display images of templates available for use by the user. When a user selects a template image, an HTML representation of the template design, including individual editable component elements (e.g., text and image elements) is passed as an input to the design page source code. In an embodiment, an identifier indicating the selected template is passed as a parameter to the server within the URL of the requested web page. This triggers the server to look up the requested template, convert it if necessary to an HTML representation, and have it placed as the content of the container 2 element within the design page 1.

In an embodiment, the active functionality of the design page 1 is implemented via script. In an embodiment, the scripting is implemented using JavaScript. In an embodiment, the zooming and scrolling control as applied to the editable visual representation of the design 3 (i.e., at the individual element level vs. the page level) operates to initialize the template element (e.g., visual representation of the design 3) as a zoomable/scrollable element. The zoom/scroll control listens for and is triggered by a start gesture event (e.g., a tap start whereby a screen touch is detected and has not been let go). Upon detection of a “start” gesture event, the zoom/scroll control determines whether it is a single touch or double touch event, listens for a “move” event, and determines the amount and direction to move based on input from a detected “move” event. If a double touch is detected, then this is classified as a “pinch” event and the focal point of the pinch is calculated as the midway point between the two screen touch locations, and the zoom level of the template element is changed in accordance with the direction and value of the pinch event. If the touch event is a single touch event, then the event is classified as a scroll event and the position of the template element is changed in accordance with the direction and value of the move event.

Zoom and scroll actions are cascaded through each of the elements nested within the template element (i.e., visual representation of the design 3). In an embodiment, the zoom and scroll functionality is implemented as an iScroll using a library of JavaScript scrolling and zooming functions called iScroll 4, available from cubiq.org. Specifically, an instance of an iScroll element is instantiated with the template element passed as the target element. When the product design page loads, JavaScript listens for DOM loaded event and then instantiates an instance of an iscroll passing the canvas as the target element.

FIG. 4A shows a schematic representation of a rendered product design page 1 rendered on a screen of an electronic display such as a mobile device. The product design page 1 contains user design functionality to allow a user to view and edit a product design. In the illustrative embodiment, the product design page 1 is a browser-renderable document, such as an HTML document, that has been rendered by a browser executing on a mobile device. The product design page 1 may be a web page of a retail product website, for example a website from which a user can design and order printed products such as business cards, postcards, brochures, invitations, announcements, banners, promotional products, etc. In the illustrative embodiment, the product design is the content to be printed to form the printed product. The product design page 1 may alternatively be directed at allowing users to design electronic products such as websites and web pages, social media pages, marketing campaign emails and advertisements, etc. In such case, the product design is the content and style to be rendered on an electronic display. The website may further be a garments or consumer products retailer which allows a user to print, emboss, engrave, stamp, apply, attach, or otherwise configure text, imagery, graphics, color onto a physical product, such that the product design page 1 may alternatively be directed at allowing users to design the particular 2-dimensional design of text, imagery, graphics, etc. that is to be applied to the selected garment or consumer product. In this case, the product design is the 2-dimensional design of text, imagery, graphics, etc. that is to be applied to the selected garment or consumer product.

The product design page 1 is configured with a product preview area, or container, 2 which contains an editable visual representation 3 of the current product design. The editable visual representation 3 is a What-You-See-Is-What-You-Get (WYSIWYG) representation of the product design as currently customized by the user. That is, the editable visual representation 3 depicts how the product design will physically look like when manufactured/rendered, including all customizations made by the user.

FIG. 4B shows a schematic representation of the browser-renderable document 1 of FIG. 4A. As illustrated, the boundaries of each of the elements of the product design page 1 are indicated by a dashed outline. (Note, the dashed outlines are present in FIG. 4B herein for purposes of indication only and are not generally visible in the rendered image of the page). As shown, the browser-renderable document 1 includes several elements including a page toolbar 8, a page heading 5, a form control 9, a customization control 6, a sample text control 7, the container 2 for display of the editable visual representation 3 of the current product design. Each element in the page 1 may include related nested elements. For example, the customization control 6 includes an icon container 6a, an icon image 6b, and icon text 6c. Similarly, the show sample text control 7 includes an icon container 7a, an icon image 7b and icon text 7c. The page toolbar 8 would similarly include multiple nested elements, which are not shown for purposes of simplicity.

The container element 2 is configured to contain therein the editable visual representation element 3. The editable visual representation of the design 3 contained therein also includes individual elements 4a, 4b, . . . , 4n corresponding to text and image elements in the represented design. For example, the editable visual representation element 3 contains nested individual elements including text fields 4a, 4b, . . . , 4k, and background image 4l.

Returning to FIG. 4A, the form control 9 can be in one of a contracted state (as shown in FIG. 4A), an expanded state (as shown in FIG. 4C), or as discussed hereinafter (relative to FIG. 4G), in a partially contracted state. Transition from the contracted state to the expanded state and vice versa is achieved through one or more predefined user input gestures such as a tap, slide, tap-and-slide, or other such finger gesture. In an embodiment, the form control 9 includes a visual expansion/contraction control 13. For example, in the contracted state (as illustrated in FIG. 4A), the form control 9 includes an expansion/contraction control 13 which appears as a selectable tab displayed along one edge of the user interface screen. The state of the expansion/contraction control 13 can be toggled from the contracted stated to the expanded state by a recognized user input gesture (such as a tap, a slide, a tap-and-swipe, etc.) that is associated with the control 13 and related toggle functionality. FIG. 4C illustrates the form control 9 and expansion/contraction control 13 when such are in the expanded state. As shown in FIG. 4C, the expansion/contraction control 13 remains visible on the screen (although has moved due to the expanded form control) to allow the user to toggle the form control 9 back to the contracted state at any time.

As further illustrated in FIG. 4C, when the form control 9 is in the expanded state, a set of user input containers, referred to as “form fields”, 9a, 9b, . . . , 9k, each corresponding to a different one of the individual text fields 4a, 4b, . . . , 4k in the visual representation 3, are displayed on the screen of the mobile device. If the number of form fields 9a, 9b, . . . , 9k exceeds the amount of screen space to reasonably render all of the form fields, the form control may include a scroll function to allow the user to scroll the expanded form control displayed to reveal form fields that are not currently visible on the screen. Each of the form fields 9a, 9b, . . . , 9k corresponds to a different one of the individual fields 4a, 4b, . . . , 4k in the product design. Thus, many if not all of the form fields 9a, 9b, . . . , 9k in the form control 9 corresponds to a different one of the individual elements 4a, 4b, . . . , 4k rendered in the visual representation 3 of the current product design. For text elements, text content entered into a corresponding form field will result in the same text content rendered and displayed as the corresponding text element in the visual representation. For image elements, the name of an image file may be entered into the corresponding image form field 4l, and the image is rendered as the image element in the visual representation of the design.

In general, the container 2 contains a visual representation of the design under construction, in its current form. Generally, the individual elements are rendered and displayed to depict the design in its current form in a What-You-See-Is-What-You-Get (WYSIWYG) depiction. Although each element is rendered to appear as it will appear in the final product, many if not all of the individual elements of the design are customizable. That is, the size, font, color, position, etc., of a given element may be user-configurable. Accordingly, many if not all of the individual elements in the visual representation of the design are configured to be individually selectable by a user via direct touch on a corresponding area of the electronic display. Thus, if a user desires to select the element 4a corresponding to the “Phone Number” field, the user can simply tap on the screen in the area where the element 4a is rendered. In order to assist the user in understanding where each element lies in the current design, the system may automatically fill in sample text for each of the fields. That is, initially, when a template is selected and loaded into the container 2 as the visual representation of the design 3 on the design page 1 for subsequent user customization, the user will not have yet entered content into the form fields 9a, 9b, . . . , 9k. In an embodiment, the system inserts sample text into the form fields 9a, 9b, . . . , 9k so that the sample text will appear in the visual representation 3 of the current product design. This may be performed in order to present an example of what type of text should be entered in each field, and to give the user an idea of how the overall layout looks when all fields are filled out. In an embodiment, as shown in FIG. 4A, the page 1 includes a show sample text control 7, which may be toggled via a recognized associated user input gesture (such as, but not limited to, a finger tap) to include or remove sample text inserted by the system. In FIG. 4A, the sample text control 7 (which may be toggled between displaying and not displaying sample text in each of the fields) has been set to display the sample text, and therefore sample text is shown in the visual representation 3. As further illustrated in FIGS. 4A and 1C, the sample text may be displayed in a color or font that is visually distinct from the standard text color or font used when a user enters text to be inserted in place of the sample text. For example, the color of the sample text may be displayed in light gray whereas user-inserted text is displayed in black. The use of a visually distinct text color or text font may be implemented to assist the user in understanding that the sample text is just that—a sample—and that the field is editable by the user to insert any desired text in its place.

A user can modify the text contained in the current product design by entering text into one or more of the form text fields 9a, 9b, . . . , 9k. Depending on the type of electronic device on which the user interface is implemented, text entry may be input by way of a keyboard, either a physical keyboard or keypad, or a virtual keypad. A virtual keypad may be invoked, for example, by the user tapping into one of the form fields 9a, 9b, . . . , 9k. Generally, the operating system of the electronic device handles detection of user input such as finger taps/gestures and processing of the user input to allow the user input to be processed by the user interface into its appropriate meaning. For example, if a user taps on a form field 9a, the operating system detects the tap event and location of the tap, determines which element corresponds to the location, and invokes the method associated with the tap event which corresponds to the object associated with the location. For example, the tap event may invoke a display of the form control 9 in a partially contracted state, as discussed hereinafter. The tap event may further invoke a listening method which accepts and processes text input received from the input device of the electronic device via the operating system. In an embodiment, when the user enters text in the one or more of the form text fields 9a, 9b, . . . , 9k, for example via a browser-invoked keypad, the text is sent to the server to be rendered in the font associated with the field. Alternatively, the text fonts are downloaded and stored locally to allow the text to be rendered locally.

Turning to FIG. 4D, for example, the form control 9 is in the expanded state, and the user has entered a phone number in the “Phone” field 9a, and is currently entering a name into the “Full Name” field 9c using a browser-invoked keypad 10. In an embodiment, the keypad 10 is displayed as a popup when a user taps (using a finger or other device) into or otherwise selects a field for editing. FIG. 4E shows the user continuing to enter text into “Job Title” field 9d using the keypad 10. The keypad 10 includes a “Done” key 11. When the user is finished entering text into a selected field, the user can tap the “Done” key on the keypad 10 to close the virtual keypad 10. The user can continue entering text into the form fields on the form control 9, or can contract the form control 9 to display the visual representation 3 of the current product design by tapping on or performing a user input gesture associated with contracting the form control 9.

FIG. 4F shows the product design page 1 after the user has contracted the form control 9 in FIG. 4E. As shown, the editable visual representation 3 is now visible, and each of the text elements 4a, 4c and 4d in the visual representation 3 corresponding to the user-edited form fields 9a, 9c and 9d in the form control 9 have been updated to incorporate the updated text.

As previously mentioned, the visual representation 3 of the current product design itself is at least partially editable. That is, certain elements, such as text elements 4a, 4b, . . . , 4k may be selected and customized directly from the visual representation 3. For example, customization options may include text styling options such as fonts, style, color, size, etc. At least in a web-browser based implementation of the user interface, elements that are editable from the editable visual representation 3 are defined as such in the HTML code used to render the representation 3. A user can select such editable elements by one of a number of gestures or user inputs recognized by the operating system of the mobile device and passed through to the appropriate page script of the design page 1. For example, in an embodiment, a user's finger tap anywhere within the boundaries of an editable element in the displayed portion of the editable visual representation on the screen of the mobile device results in selection of that particular element. As illustrated in FIG. 4G, a field's status as “selected” may be indicated by displaying the selected element within a shadowed box 14a, or by another alternate visual indicator, on the visual representation of the design 3.

To assist the user in performing customization options directly from the visual representation 3, the design page 1 includes a customization control 6. In an embodiment, the customization control 6 can be in either a contracted state (as shown in FIG. 4A) or in an expanded state (as shown in FIG. 4G). In the expanded state, the customization control 6 may provide a number of different controls 15a, 15b, . . . , 15e which are tools to assist the user in editing or modifying the selected element. In the illustrative embodiment, the expanded customization control 6 is implemented as a toolbar, with different icons associated with different stylistic modifications. For example, when the selected element is a text element, the toolbar may contain icons for editing the font (15a), the case (15b), the bold style (15c), the italicized style (15d), and the text color (15e).

Each icon 15a, 15b, . . . , 15e is associated with different page script to provide different functionality. For example, if the user taps on the font selection icon 15e, a list 18 of available fonts is displayed, as shown in FIG. 4H. Preferably, the current font is highlighted or alternatively some indication is displayed to indicate which font is currently used for the selected element. The user can modify the current font for the selected element by locating the desired font in the list 18 (scrolling where needed), and performing the user input gesture associated with selection (e.g., a single or double tap). The visual representation is then updated, and the underlying product design is modified according to the user selections. FIGS. 1I and 1J show the editable visual representation 3 being updated after the user clicks the “bold” style icon 15c (FIG. 4I) and then on the “italicized” style icon 15d (FIG. 4J).

FIG. 4K shows a color picker control 19 which is displayed when the user selects the “color” style icon 15e. As shown, the color picker control 19 displays a number of different colors available for use for the selected element. In an embodiment, the colors are displayed as an m×n array of individual color icons. In the illustrative embodiment, the color icons are circles filled with a corresponding color, and each has associated therewith a script which results in the modification of the current color associated with the selected element to the color associated with the particular color icon. Thus, a user can select a new color for the selected element by performing the selection gesture associated with color icon filled with the desired color. For example, the selection gesture may be a tap. A tap on a particular icon will update the color of the selected element with the color associated with the icon.

As an additional feature, the color 23 (see FIG. 4J) of the icon 15e of the “color” style icon 15e may take on the currently selected color of the selected element. Thus, if the user updates the color of the selected element from the current color 24 to a new color 25 using the color picker control 19, when the color picker control 19 is closed, as illustrated in FIG. 4L, the color of both the selected element (for example, selected element 4a) in the editable visual representation 3 of the current product design and the color of the “color” style icon 15e in the customization control 6 is updated with the new color 25.

In an embodiment, the color picker control 19 also includes a palette area 20 which displays the current color and a set of recently used colors from the available colors. This allows the user to “test” a color by selecting a new color from the color picker control 19, viewing the selected element with the “new” color applied, returning to the color picker 19 if the user desires to try yet another new color or to return to the old color. Although not shown, preferably the color picker control 19 provides a scrolling functionality to allow more colors to be displayed via scrolling. In an embodiment, in order to save space on the screen for content rendering rather than control rendering, the scroll is implied, meaning that the scrolling functionality exists without the visible scrollbar so that when the user performs a scrolling gesture (such as a tap and slide in the downward (or upward) direction, the content of the color picker control 19 scrolls downward (or upward) to reveal more available colors. FIG. 4M shows the color picker control 19 after replacement of the color 24 with the color 25 for the selected element. Notably, the currently selected color is distinguished from all other colors by a visual differentiation. In the illustrative embodiment the visual differentiation is the size of the circle (in particular, in this case, the selected color 25 is indicated by having a smaller sized circle, whereas all unselected colors are of equal but larger sized circles). However, it will be appreciated by those skilled in the art that many different visual differentiation implementations exist and that the illustrative embodiment is for visual differentiation is presented herein only by way of illustration and not by way of limitation.

Any editable element can be selected and customized in a manner similar to that illustrated via FIGS. 1A-1M. FIG. 4N shows the design page 1 after the user selects element 4h. It will be noted in this view that due to the resolution limitations of the smaller screen size of the mobile device, that the size of the element 4h is quite small for viewing purposes. For this reason, a feature of the present invention is the provision of zooming functionality of the editable visual representation 3 of the current product design. To this end, the design page attaches zooming (and preferably scrolling) functionality to the container 2 in which the editable visual representation 3 is contained. The container 2 is configured to hide any portion of its content that lies outside the defined boundaries of the container 2. All of the elements 4a-4l are defined with absolute positioning relative to the editable visual representation element 3, and the zooming control is cascaded down through any nested elements of the editable visual representation element 3 such that if the zoom level of the editable visual representation element 3 is changed, all of the elements 4a-4l are also proportionally zoomed.

FIG. 4O illustrates the user performing an outward “pinch” gesture, whereby the user simultaneously touches the screen of the mobile device with the thumb 26 and forefinger 27 located about a focal point 28, and then simultaneously moves both the thumb 26 and forefinger 27 in opposite directions. The point on the screen that is midway between the thumb 26 and forefinger 27 is considered the focal point, and the distance in combination with the speed of the outward movement of the thumb 26 and forefinger 27 determines the amount of zoom. In the present case, an outward pinch gesture corresponds to a zoom-in request (and an inward-direction pinch gesture corresponds to a zoom-out request). Other gestures or user input means could be implemented to capture the focal point and zoom level if desired.

FIG. 4P shows the design page 1 after the zoom level within the editable visual representation 3 of the current product design has been adjusted (as illustrated by the pinch gesture in FIG. 4O). As illustrated, the selected element 14h is not fully visible. For this reason, a further feature of the present invention is the provision of scrolling functionality of the editable visual representation 3 of the current product design. To this end, the design page attaches scrolling functionality to the container 2 in which the editable visual representation 3 is contained. As explained above in relation to providing zooming control, the container is configured to hide any portion of its content that lies outside the defined boundaries of the container 2, and all of the elements 4a-4l are defined with absolute positioning relative to the editable visual representation element 3. Thus, the entire editable visual representation 3 and its component elements are treated as one unit by the scrolling and zooming controls.

The scrolling control allows a user to move the underlying editable visual representation 3 of the current product design so as to position an area of interest of the editable visual representation 3 so as to be displayed within the defined dimensions of the container 2. Thus, in reference to FIG. 4P, in order to move the underlying editable visual representation 3 of the current product design so as to position the selected field 14h into full view inside the container 3, the user can perform a scrolling gesture. In the illustrative embodiment, the scrolling gesture is a tap-and-slide motion in the direction that the underlying editable visual representation 3 should be moved. FIG. 4P shows the user performing the tap-and-slide motion with the user's forefinger 27. FIG. 4Q shows the resulting display. As will be appreciated from FIG. 4Q, the selected field 14h is sufficiently large to easily view its content and presentation style.

FIG. 4R shows the selected element 14h after further zooming and scrolling. Note additionally that the other design page elements (e.g., the header 5, the customization control 6, the partially contracted field control 16, etc.) are not zoomed. That is, the zoom control associated with the editable visual representation 3 is independent of zooming and scrolling control of the design page itself.

Returning now to FIG. 4G, in order to add further user assistance in editing the product design, once a user has selected an element (e.g., element 4a), the design page 1 displays a partially contracted version of the form control 9 by displaying an associated form field 16a which is directly linked to the selected element 4a (and to the corresponding form field 9a in the full form control 9). The current content of the selected element 4a is displayed as the content of the form field 16a. In the partially contracted version of the form control 9, the form fields 9a, 9b, . . . , 9k, corresponding to the currently unselected elements 4b, . . . , 4k, in the visual representation 3 are hidden; however, the user can toggle to the next or previous field using navigation buttons 17a and 17b. Toggling to the next or previous field in the form control 9 results in the selection of the next or previous corresponding ordered element in the visual representation 3. Thus, if the user taps on navigation button 17a on the screen shown in FIG. 4G (after making various additional style edits), the element 14b corresponding to the next ordered field 9b in the form control 9 will be selected as indicated in the editable visual representation 3 of the current product design of FIG. 4S. The partially contracted version 16 of the form control 9 is updated to display an associated form field 16b which is directly linked to the selected element 4b (and to the corresponding form field 9b in the full form control 9). The current content of the selected element 4b is displayed as the content of the form field 16b. The user can thus navigate from field to field, making edits to the field/element using the customization tools 6, while simultaneously viewing the editable visual representation 3 of the current product design. In an embodiment, the form field 16b merely displays the content of the field; in an alternative embodiment, the user can edit the content of the form field 16b which is then propagated to the corresponding form field 9b and the content is rendered and updated within the editable visual representation 3 of the current product design. FIG. 4T shows a snapshot of the design page 1 after the user has selected the Next navigation button 17a. Again, the partially contracted version 16 of the form control 9 is updated to display an associated form field 16c which is directly linked to the next automatically selected element 4c (and to the corresponding form field 9c in the full form control 9). The current content of the selected element 4c is displayed as the content of the form field 16c.

In sum, the design page 1 includes features that are particular optimal for designing customized products from mobile devices. By integrating form control with WYWIWYG presentation and including zoom and edit control directly on the visual presentation element itself, users of mobile device experience a cleaner simplified design process, leading to more satisfied customers.

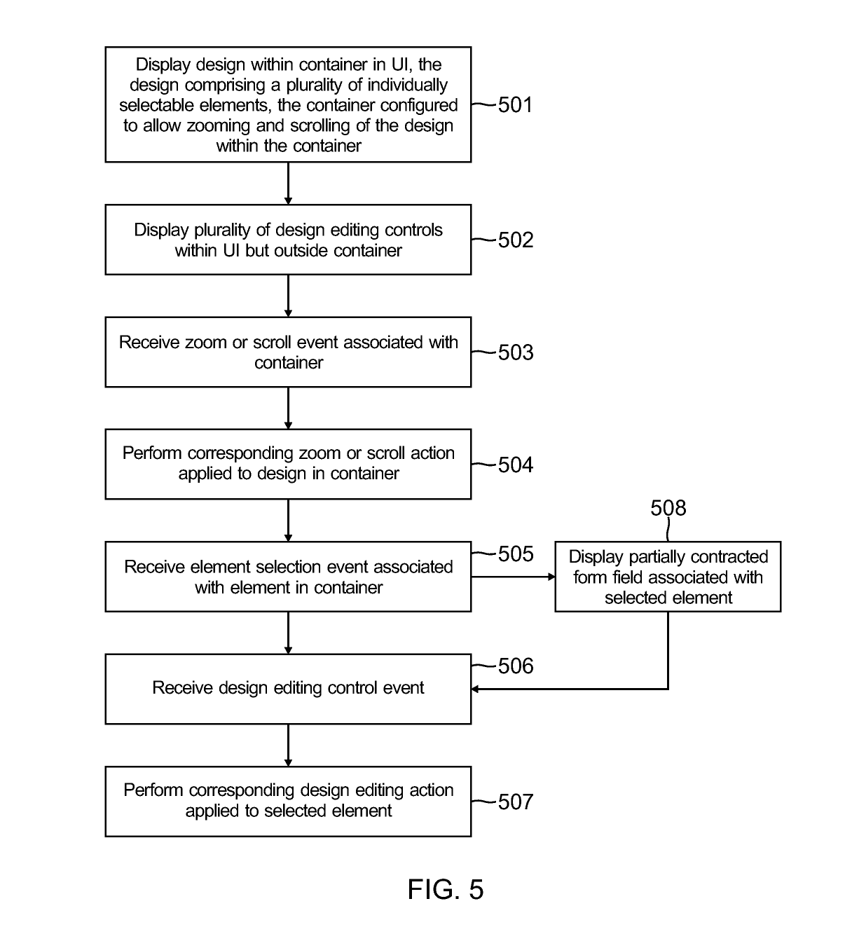

FIG. 5 is a flowchart illustrating an exemplary user interface methodology for enabling a user of an electronic device to customize a product design via a user interface displayed on an electronic device. As illustrated therein, the method includes the step of displaying in the user interface a design within a container, the design comprising a plurality of individually selectable elements, the container configured to allow zooming and scrolling of the design within the container (step 501). Within the user interface and outside the container, a plurality of design editing controls is displayed. (step 502). At least one of a zoom event and a scroll event associated with the container is received (step 503) and a corresponding zooming or scrolling action to zoom or scroll the design within the container is performed (step 504), wherein the design editing controls are unaffected by zooming or scrolling action. At least one selection event within the container is received (step 505) which corresponds to a user's selection of an individual element of the design. At least one design editing control event is received (step 506), and a corresponding design edit action associated with the received design editing control event is performed (step 507) on the selected individual element of the design. Optionally, the at least one selection event (received in step 505) triggers display of a partially contracted form field control which displays a user editable input field for editing content of the selected individual element of the design (step 506).

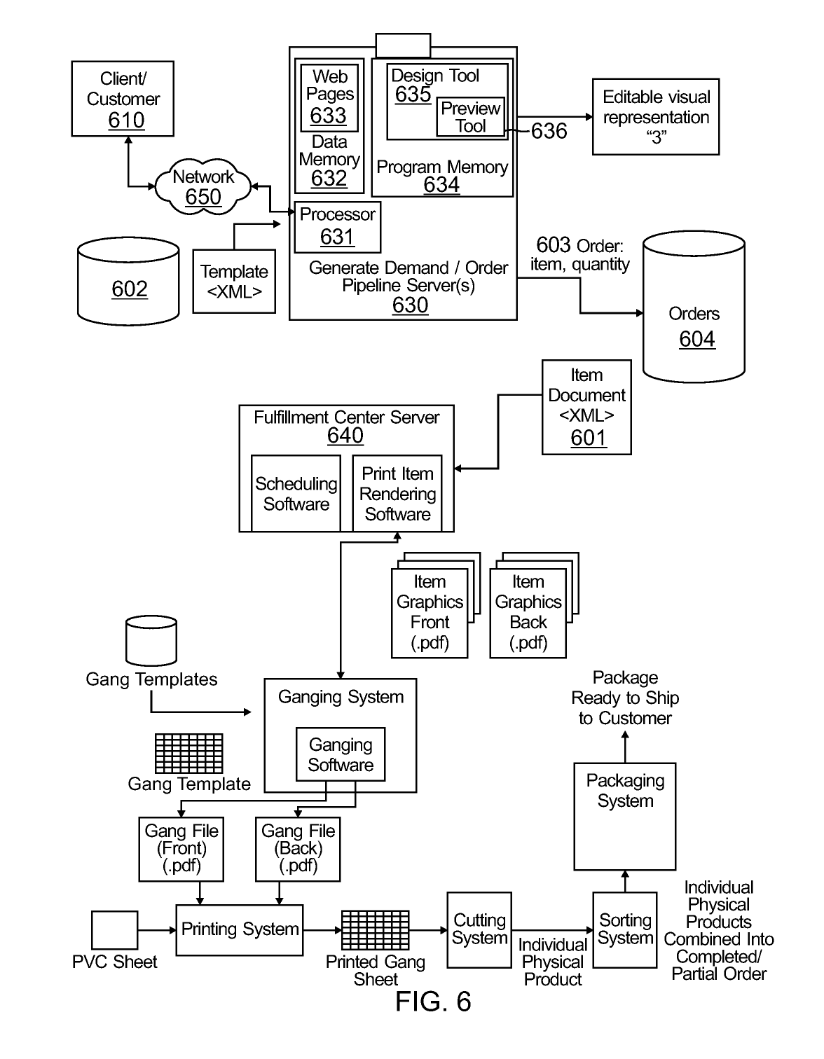

FIG. 6 illustrates a high-level block diagram of an exemplary embodiment of a system 600 in which the present invention may be applied. As shown in FIG. 6, an online retailer offering printed products provisions a Generate Demand/Order Pipeline server 630 with a website. Product content, such as templates, layouts, designs, font schemes, color schemes, images, graphics, available for various products are provisioned into a content database 602 or other computer storage by human or computer designers.

Any number of customers operating client devices 610 may access the website hosted by the Generate Demand server(s) 630 to view products and product templates and to select, design, and/or customize various design components of a selected product prior to ordering. For example, multiple templates for a product such as a business card may be selectable by the customer for further customization such as adding customer-personalized information such as name, business name, address, phone number, website URL, taglines, etc. Furthermore, the template may include image containers allowing the user to upload images into the product design. Once a customer is satisfied with their selections/customizations, they can place an order 603 through the server 630. Orders 603 are stored in an order database 604 and/or sent directly to a fulfillment center. A server 640 at a fulfillment center may retrieve orders 603 from the order database 604, extract individual item documents 601 from the retrieved orders 603, convert the individual item documents 601 into a set of related individual postscript files which are then aggregated into a set of related gangs files containing the individual items to be manufactured. The gang files are sent to a printing system and the items are simultaneously manufactured a “gang” at a time. Manufactured items are sorted by a sorting system back into their individual orders, packaged and shipped or otherwise delivered to the respective individual customers.

In general, the orders 603 submitted by customers are short run manufacturing jobs, i.e., manufacturing jobs of products of a particular design and shape of less than 40,000 units, typically 1-5,000 units). Through a network 650, each customer can access a website comprising a plurality of related web pages 633 configured to allow a customer to select and customize a graphical design or template to be printed, etched, engraved, stamped, affixed, or otherwise embodied on a product (e.g., business cards, brochures, invitations, announcements, promotional products such as keychains, mousepads, magnets, decals, etc.). Design tool(s) 633 including the user interface software may execute directly on the Generate Demand/Order Pipeline server 630, or may be downloaded 614 from the server 630 as part of web pages 633 displayed to the user to run in the user's browser 613 on the customer's electronic device 610. In an embodiment, the design tool(s) 614, 635 enable the user to perform simple design functions by completing a selected template using the user interface of the present invention. In an embodiment, the templates are embodied using an XML format or other appropriate format.

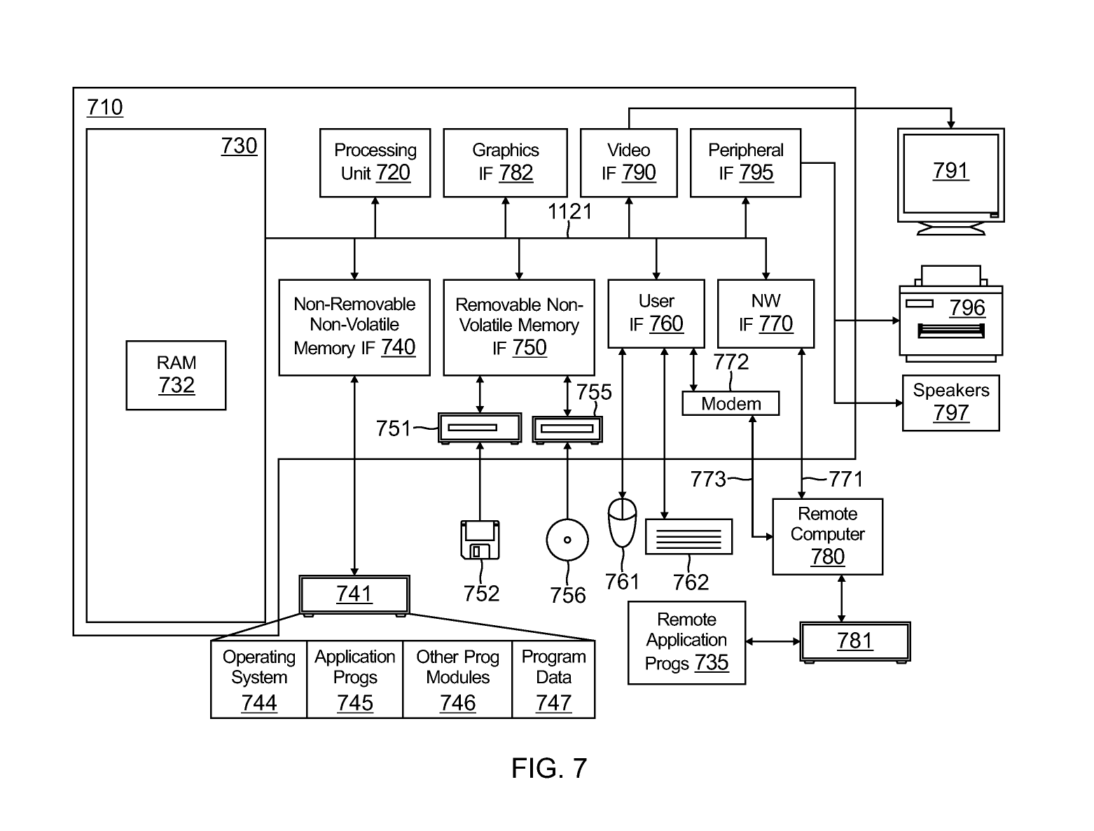

FIG. 7 illustrates a computer system 710 that may be used to implement any of the servers and computer systems discussed herein. Components of computer 710 may include, but are not limited to, a processing unit 720, a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures.

Computer 710 typically includes a variety of computer readable media. Computer readable media can be any available media that can be accessed by computer 710 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 710. Computer storage media typically embodies computer readable instructions, data structures, program modules or other data.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. F illustrates operating system 734, application programs 735, other program modules 736, and program data 737.

The computer 710 may also include other removable/non-removable, volatile/nonvolatile computer storage media. By way of example only, FIG. F illustrates a hard disk drive 740 that reads from or writes to non-removable, nonvolatile magnetic media, a magnetic disk drive 751 that reads from or writes to a removable, nonvolatile magnetic disk 752, and an optical disk drive 755 that reads from or writes to a removable, nonvolatile optical disk 756, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740, and magnetic disk drive 751 and optical disk drive 755 are typically connected to the system bus 721 by a removable memory interface, such as interface 750.

The drives and their associated computer storage media discussed above and illustrated in FIG. F provide storage of computer readable instructions, data structures, program modules and other data for the computer 710. In FIG. F, for example, hard disk drive 741 is illustrated as storing operating system 744, application programs 745, other program modules 746, and program data 747. Note that these components can either be the same as or different from operating system 734, application programs 735, other program modules 736, and program data 737. Operating system 744, application programs 745, other program modules 746, and program data 747 are given different numbers here to illustrate that, at a minimum, they are different copies. A user may enter commands and information into the computer 710 through input devices such as a keyboard 762 and pointing device 761, commonly referred to as a mouse, trackball or touch pad. Other input devices (not shown) may include a microphone, joystick, game pad, satellite dish, scanner, or the like. These and other input devices are often connected to the processing unit 720 through a user input interface 760 that is coupled to the system bus, but may be connected by other interface and bus structures, such as a parallel port, game port or a universal serial bus (USB). A monitor 791 or other type of display device is also connected to the system bus 721 via an interface, such as a video interface 790. In addition to the monitor, computers may also include other peripheral output devices such as speakers 797 and printer 796, which may be connected through an output peripheral interface 790.

The computer 710 may operate in a networked environment using logical connections to one or more remote computers, such as a remote computer 780. The remote computer 780 may be a personal computer, a server, a router, a network PC, a peer device or other common network node, and typically includes many or all of the elements described above relative to the computer 710, although only a memory storage device 781 has been illustrated in FIG. F. The logical connections depicted in FIG. F include a local area network (LAN) 771 and a wide area network (WAN) 773, but may also include other networks. Such networking environments are commonplace in offices, enterprise-wide computer networks, intranets and the Internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the Internet. The modem 772, which may be internal or external, may be connected to the system bus 721 via the user input interface 760, or other appropriate mechanism. In a networked environment, program modules depicted relative to the computer 710, or portions thereof, may be stored in the remote memory storage device. By way of example, and not limitation, FIG. F illustrates remote application programs 785 as residing on memory device 781. It will be appreciated that the network connections shown are exemplary and other means of establishing a communications link between the computers may be used.

Although the present invention is described above by way of various embodiments that include specific structures and methods, embodiments that include alternative structures and methods may be employed without departing from the principles of the invention described herein.

What is claimed is:

1. A user interface for customizing a product design, comprising:
a preview container containing a visual representation of the design displayed on an electronic display, the visual representation of the design depicting the design in its current form in a What-You-See-Is-What-You-Get (WYSIWYG) depiction, the visual representation of the design having a plurality of customizable elements that are individually selectable by a user via direct touch on a corresponding area of the electronic display;
a plurality of user interface controls, the plurality of user interface controls comprising:
a form control responsive to user input to set the form control into one of a plurality of form control states including at least an expanded state, a contracted state, and a partially contracted state, wherein
the expanded state is configured to expose for display on the electronic display a plurality of user-editable form fields corresponding to the plurality of customizable elements of the visual representation of the design and wherein each user-editable field is configured to receive content from the user whereby the received content corresponds to corresponding visual content of the corresponding element in the visual representation of the design,
the contracted state is configured to hide the user-editable form fields from view on the electronic display, and
the partially contracted state is configured to display on the electronic display only the user-editable form fields corresponding to currently selected elements in the visual representation of the design;
a customization control responsive to user input to set the customization control into one of a plurality of customization control states including at least a contracted customization control state in which an expanded set of customization option controls is hidden from view on the electronic display and an expanded customization control state in which the expanded set of customization option controls is exposed for view on the electronic display and for user interaction, the set of customization controls configured to allow the user to configure different visual features of the visual content of the respective elements in the visual representation of the design;
wherein the preview container is configured to allow a user to scroll and zoom the visual representation of the design within the preview container without simultaneously scrolling or zooming the user interface controls on the electronic display, and
wherein direct touch selection of an individual customizable element on the visual representation of the design triggers display of the form control configured in the partially contracted state.

2. A method for enabling a user of an electronic device to customize a product design via a user interface displayed on an electronic device, the method comprising:
displaying in the user interface a design within a container, the design comprising a plurality of individually selectable elements, the container configured to allow zooming and scrolling of the design within the container;
displaying, within the user interface and outside the container, a plurality of design editing controls;
receiving at least one of a zoom event and a scroll event associated with the container and performing corresponding zooming or scrolling action to zoom or scroll the design within the container, wherein the design editing controls are unaffected by zooming or scrolling action;
receiving at least one selection event within the container, the at least one selection event corresponding to use selection of an individual element of the design;
receiving at least one design editing control events and performing a corresponding design edit action associated with the received design editing control event, the action performed on the selected individual element of the design.

3. The method of claim 2, wherein the at least one selection event triggers display of a partially contracted form field control which displays a user editable input field for editing content of the selected individual element of the design.
